(19) United States
(12) Patent Application Publication
(10) Pub. No.: US 2016/0066511 A1
(43) Pub. Date: Mar. 10, 2016

(54) TARGET DESIGNATING DISPENSING SYSTEM AND METHOD FOR THE SAME

(71) Applicant: Raven Industries, Inc., Sioux Falls, SD (US)

(72) Inventors: John Earl Acheson, Sioux Falls, SD (US); Thomas C. Obermark, Brooklyn Park, MN (US)

(21) Appl. No.: 14/844,566

(22) Filed: Sep. 3, 2015

Related U.S. Application Data
(60) Provisional application No. 62/046,637, filed on Sep. 5, 2014.

(51) Int. Cl. A01D 75/02; B65G 67/04

(52) U.S. Cl. CPC A01D 75/02; B65G 67/04

(57) ABSTRACT

A target designating dispensing system includes a targeting actuator interface configured for coupling with a targeting actuator of a tool, such as a dispenser. A target designator of the system includes a dispensing target display that provides a dispensing target representation and a designator reticle movable in the dispensing target display. A targeting controller communicates with the targeting actuator interface and the target designator. The targeting controller includes an indexing module that associates a designator reticle location on the representation of the dispensing target to a flow target on the dispensing target. An actuator control module of the targeting controller communicates with the targeting actuator to direct the dispenser at the flow target. In an example, the actuator control module maintains the direction of the dispenser at the flow target with movement of one or more of the dispensing target or the flow target relative to the dispenser.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raven Industries, Inc.; Sioux Falls, S. Dak. All Rights Reserved.

### TECHNICAL FIELD

This document pertains generally, but not by way of limitation, to dispensing systems, targeting systems and control of dispensing and targeting systems.

### BACKGROUND

Harvesters and grain carts coupled with harvesters (e.g., a tender) include dispensers (e.g., augers) configured to lift and dispense harvested crops into a grain cart pulled along the harvester. For instance, in an example a tractor pulling a grain cart moves through a field adjacent to a moving harvester to receive harvested crops from the harvester or a tendered grain cart coupled with the harvester. The dispenser includes a dispenser nozzle. The harvested crops are drawn from a reservoir by the dispenser (e.g., an auger) and delivered through the dispenser nozzle to the grain cart of the vehicle. In another example, grain carts pulled by tractors dispense harvested crops (e.g., received from a harvester) to the grain hauler of a truck, for instance, a dispenser including an auger and a dispenser nozzle.

The operator of the harvester monitors the output of the dispenser and adjusts the orientation of the dispenser nozzle with a remote system. For instance, in one example, a series of directional controls (buttons) are used to adjust the orientation of the dispenser nozzle. In another example, a joystick is operated to adjust the orientation. As the grain cart (of the tractor or grain hauler of the truck) is filled at a location of the grain cart, such as the back, the operator adjusts the orientation of the dispenser nozzle with the directional controls toward an unfilled (or lesser filled) location of the grain hauler. During movement through a field the harvester (and optional tendered grain cart) and the tractor (including its grain cart) move relative to each other. Accordingly, to prevent spilling and maintain the direction of flow of the harvested crop from the dispenser nozzle to a desired location of the grain cart (of the tractor) the operator monitors and continues to make on-going orientation changes to the dispenser (e.g., the dispenser nozzle or swing auger).

Similarly, in other dispenser type arrangements (water spraying, foam or water based firefighting applications, water or foam dropping aircraft, crop dusting, or the like) one or more of the device, vehicle, terrain or the like moves relative to one another. The operator in each of these circumstances uses hand controls (buttons, joy sticks, levers, or the like) to guide the application of a product, such as water, agricultural products or the like while a vehicle is moving or the target object is moving (or dynamically changing). Stated another way, the target and dispenser move relative to each other. The operator in turn in an on-going basis adjusts the orientation of the dispenser according to these changes to thereby redirect the product to the updated target.

### OVERVIEW

The present inventors have recognized, among other things, that a problem to be solved can include facilitating operator control of a dispenser. For instance, the operator of a harvester uses directional controls to orient the dispenser nozzle of a harvester or grain cart coupled with a harvester to a location of a dispensing target, such as a grain cart pulled by a tractor. In another example, a dispenser of a grain cart (e.g., coupled with a tractor) is used to transfer harvested crop to a grain hauler coupled with a truck. In previous examples directional buttons, joysticks or the like are used to control the direction of flow from the dispenser. Stated another way, the user provides a series of commands (combinations of right, left, forward, backward, and the like) through the directional buttons, joystick or the like to manually and tediously guide the direction of flow from the dispenser. As the grain cart (or hauler) fills the operator must readjust the orientation of the dispenser (again with a series of commands provided through manual guidance with buttons a joystick or the like) to account for filling.

In an example, the present subject matter can provide a solution to this problem, such as by implementing a target designating dispensing system that directs a tool such as a dispenser (e.g., a nozzle of the dispenser) and a corresponding flow of a product toward a flow target of a dispensing target such as a location within a grain cart. The target designating dispensing system directs the dispenser toward the flow target and maintains the direction at the flow target, for instance by providing automated adjustment to the dispenser direction. In one example, a target (designator) reticle is moved with touch interaction on a screen to a desired location of a representation of the dispensing target. The representation is, in another example, a video or still image feed of the dispensing target. The designator reticle is positioned at a desired location for filling, and the location is indexed to the corresponding location (flow target) of the dispensing target by a dispensing controller. The dispensing controller automatically orients the dispenser (nozzle) toward the flow target and accordingly directs the flow of the harvested product, such as a crop, to the flow target. A series of directional commands to change the dispenser orientation are not needed. Instead, the dispensing controller automatically changes the orientation of the dispenser according to the position of the designator reticle. As the designator reticle position is changed (i.e., to fill other portions of a grain cart or hauler to avoid spills) the dispensing controller automatically changes the dispenser orientation to the new flow target without tedious directional commands from the operator.

The present inventors have further recognized, among other things, that a problem to be solved can include minimizing operator control of a dispenser while orienting the dispenser in a dynamic environment. For instance, the operator of a harvester uses directional controls to orient the dispenser nozzle of a harvester or grain cart coupled with a harvester to a location of a dispensing target, such as a grain cart pulled by a tractor. As the grain cart fills or the grain cart moves relative to the dispenser (harvester) the operator must readjust the orientation to account for filling and relative movement.

In an example, the present subject matter can provide a solution to this problem, such as by implementing a target designating dispensing system that directs a tool, such as a dispenser (e.g., a nozzle of the dispenser) and a corresponding flow of a product, toward a flow target of a dispensing target such as a location within a grain cart. The target designating dispensing system directs the dispenser toward the flow target and maintains the direction at the flow target, for instance by providing automated adjustment to the dispenser direction. In one example, a target (designator) reticle is moved with touch interaction to a desired location for filling, and the location is indexed to the corresponding location (flow target) of the dispensing target by a dispensing controller. The dispensing controller automatically orients the dispenser (nozzle) toward the flow target and accordingly directs the flow of the harvested product, such as a crop, to the flow target.

The target designating dispensing system maintains the dispenser orientated toward the flow target even with dynamic changes to one or more of the flow target or the dispenser. For instance, even with relative movement between the flow target and the dispenser (a tractor and cart drifts away from a harvester dispenser, or the like) the dispensing controller maintains the dispenser directed at the flow target. The location of the flow target is initially fixed relative to the dispenser, for instance at the time the designator reticle location is associated with the flow target. A motion sensor measures movement of the flow target to a current location relative to the previously fixed location of the flow target, for instance by way of Cartesian coordinate changes, and the controller maintains the direction of the dispenser at the flow target based on the difference between a current location of the flow target and its previously fixed location. The operator therefore designates a flow target with the designator reticle, and the dispensing controller automatically ensures the dispenser delivers the flow of the harvested product, such as a crop, to the flow target even with relative movement between the flow target and the dispenser. Stated another way, the dispensing controller ensures the dispenser nozzle of the dispenser automatically tracks to the location of the designator reticle without direct and on-going intervention by an operator otherwise using directional controls.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of one example of a harvester offloading a harvested crop to a grain cart.

FIG. 2 is a perspective view of one example of a tractor and grain cart offloading a harvested crop to a truck and grain hauler.

FIG. 3 is a schematic top view of the harvester and grain cart of FIG. 1 with a dispensing nozzle directed toward a flow target.

FIG. 4 is a schematic diagram one example of a target designating and actuation system.

FIG. 5A is a schematic diagram of another example of a target designating and actuation system in communication with a dispensing nozzle for dispensing a harvested at a first designated flow target.

FIG. 5B is a schematic diagram of a user interface and real time dispensing of a harvested crop at a second designated flow target.

FIG. 6A is a schematic diagram of the user interface and real time dispensing of the harvested crop at a third designated flow target.

FIG. 6B is a schematic diagram of the user interface and real time dispensing of the harvested crop at the third designated flow target of FIG. 6A with the dispensing target relatively moved.

FIG. 7 is a block diagram showing one example of a method for directing a dispenser to a flow target.

### DETAILED DESCRIPTION

An augmented reality loading system (e.g., a target designating dispensing system) includes a sensor, such as a camera, a user interface device such (e.g., touchscreen, smart phone, tablet computer or the like), and a controller including image processing modules (e.g., for calibration of the system and graduation of tool movement based on designator reticle location) and an actuator control module to manipulate a tool such as a dispenser (e.g., a grain nozzle, sensor such as a scanner, a weapon such as a gun or the like). In one example, the tool includes a grain nozzle for grain handling applications on a grain cart. In another example, the tool includes a liquid or particulate dispenser, for instance for aerosol or liquid based fire extinguishing or suppressing applications. In yet another example, the tool includes a dispenser for use with the dispensing of liquids, such as water, agricultural products or the like in agricultural and non-agricultural applications where accurate dispensing and maintenance of the direction of dispensing to a flow target is useful. In still other examples, the tool includes, but is not limited to, a sensor such as a scanner configured to provide detailed information about a target, a weapon such as a gun, delivery system (e.g., rockets or missiles) or the like.

The camera, for instance mounted on a dispenser nozzle (e.g., an unload auger spout) provides one or more of still images of a dispensing target, such as a grain hauler, at specific intervals or a video stream sent through an interface box to a controller and displayed through the augmented reality software (e.g., as a representation of the dispensing target). To direct the movements of the unload auger spout (the dispenser nozzle), and the flow of a product such as harvested grain, the user interacts with a touch screen and taps or drags a finger (and a visible or non-visible designator reticle) across the image (representation of the dispensing target) to the desired position (a flow target within the dispensing target). The controller indexes the location of the designator reticle on the representation to the corresponding location (flow target) within the dispensing target. The controller then operates the articulating mechanism for the dispenser nozzle (or other tool as described herein) and directs the nozzle toward the flow target. The flow of product, such as harvested crop, is directed to the flow target of the dispensing target (e.g., a grain hauler). Even with relative movement between the dispenser and the flow target (shifting of a trailer relative to a harvester) the controller maintains the dispensing nozzle directed at the flow target according to the indexed location of the designator reticle. Stated another way, the controller adjusts the orientation of the dispenser nozzle according to measured relative movement to maintain direction of the nozzle at the flow target until changed by the operator.

This subject matter is used for controlling the flow of a material handling system for loading or unloading of materials. Examples include, but are not limited to, filling barges with materials, filling hoppers on forage harvesters and loading of trains.

This system eliminates joystick control (or other similar control schemes) and provides an overhead view of the interior of the cart bed as it fills with grain. Accordingly, the operator is provided with a representation of the dispensing target that includes information about the filling status of portions of the dispensing target (cart bed) as it fills. Further, the operator is able to concentrate on operation of a vehicle such as a harvester without continuously (e.g., in an ongoing manner) readjusting the orientation of the dispenser nozzle (grain spout) to account for relative movement between the dispensing target (truck bed) and the dispenser (harvester or grain hauler auger).

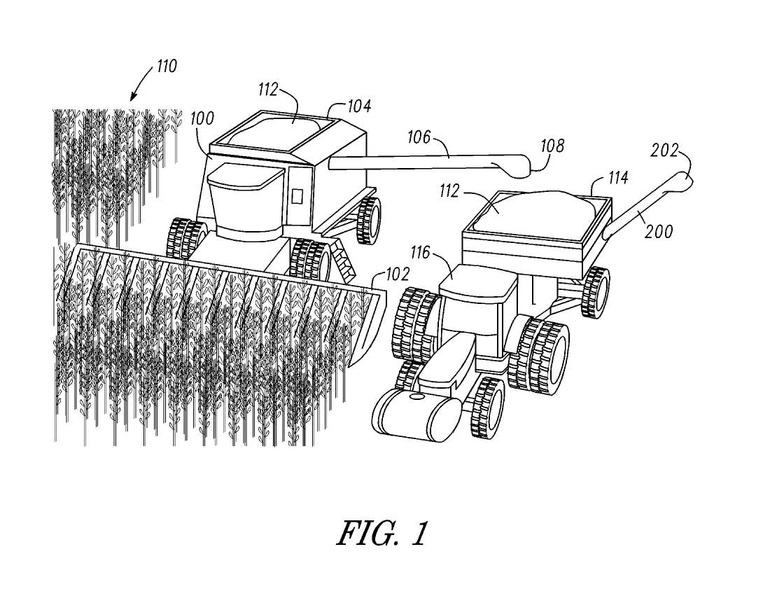

FIG. 1 shows one example of a harvesting arrangement of vehicles including a harvester 100 and a vehicle 116 (e.g., a tractor, truck, another harvester or the like). As shown in FIG. 1, the harvester 100 is in the process of harvesting a crop 110. For instance, the harvester 100 includes a harvesting implement 102 sized and shaped to harvest one or more crops from a field. The harvester 100 further includes a crop bin 104 that holds the processed crop for instance (a harvested crop 112) prior to delivery, for instance to a grain cart, such as the grain cart 114.

As further shown in FIG. 1, the vehicle 116 is coupled with the grain cart 114. In one example, the grain cart 114 corresponds to a dispensing target as described herein. The grain cart 114 is configured to hold a specified volume of the harvested crop 112. In another example, the harvested crop 112 is held within the grain cart 114 and delivered to another dispensing target such as a grain hauler coupled with a truck.

Referring again to FIG. 1, the harvester 100, the vehicle 116 and the grain cart 114 are arranged so a dispenser 106 of the harvester 100 is directed toward the grain cart 114. In the example shown, the dispenser 106 includes a dispenser nozzle 108 sized and shaped to provide a stream of the harvested crop 112 into the grain cart 114. Optionally, the dispenser 106 includes an actuator mechanism in the dispenser nozzle 108. The operator of the harvester 100 controls the actuator in the dispenser nozzle 108 to adjust, on an ongoing basis, the direction of the stream of harvested crop 112 exiting the dispenser 106. For instance, one or more of the dispenser 106 and the dispenser nozzle 108 includes one or more servo motors, actuators, tendons or the like configured to move the dispenser nozzle 108 as desired by the operator on an ongoing basis to direct the flow of harvested crop 112 to the various portions of the grain cart 114 to fully fill the grain cart 114 prior to departure of the vehicle 116 from the harvester 100. The operator also manipulates the dispenser nozzle 108 to account for relative movement between the harvester 100 and the vehicle 116 and the grain cart 114.

In another example, the dispenser 106 includes an actuator associated with the base of the dispenser. For instance, the dispenser 106 is a swing arm type dispenser extending to the dispenser nozzle 108. The swinging dispenser 106 includes one or more actuators for instance associated with the base of the dispenser 106 and the harvester 100. In a similar manner to the example previously described herein, the operator of the harvester 100 in an ongoing manner provides control instructions of the dispenser 106 through one or more controls within the cab of the harvester 100. The dispenser 106, including the dispenser nozzle 108, is thereby traversed forward, backward or the like relative to the grain cart 114 to accordingly fill the grain cart as previously described herein. The operator also manipulates the dispenser 106 to account for relative movement between the harvester 100 and the vehicle 116 and the grain cart 114.

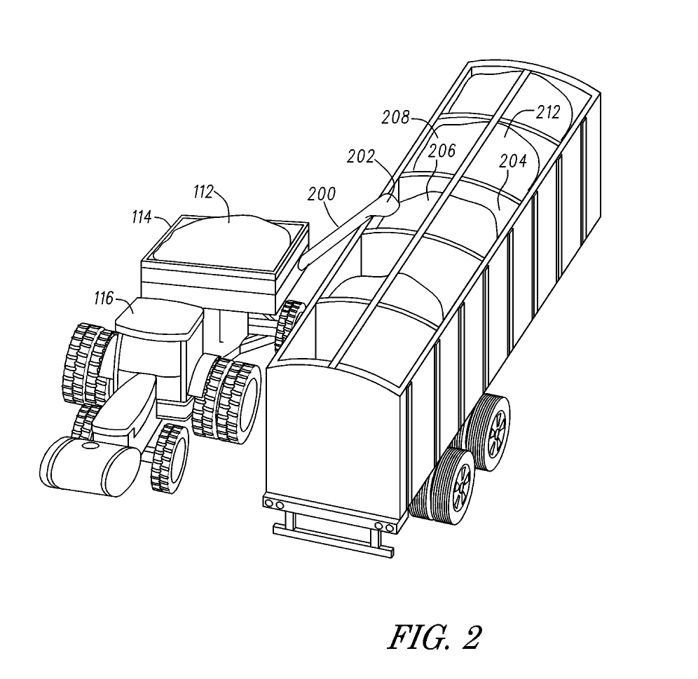

Referring now to FIG. 2, the vehicle 116 (e.g., a tractor) is shown in an offloading configuration with the vehicle 116 and the grain cart 114 positioned adjacent to another dispensing target, such as a grain hauler 204. As shown in FIG. 2, the grain hauler 204 includes at least a first grain reservoir 206 and a second grain reservoir 208. In one example, the first and second grain reservoirs 206, 208 correspond to first and second flow targets. As further shown in FIG. 2, the dispenser 200 of the grain cart 114 is in a deployed position and positioned adjacent to the grain hauler 204 with the dispenser nozzle 202 directed into the grain hauler 204 for instance towards the first grain reservoir 206.

As with the discussion of the dispenser 106, in one example, the dispenser 200 shown in FIG. 2 includes an articulating dispenser nozzle 202 configured to accordingly adjust the direction of the flowing stream of the harvested crop 112 into the grain hauler 204. In another example, the dispenser 200 is a swing arm type dispenser including one or more actuators at the base of the dispenser 200 configured to traverse the dispenser 200 in a forward and backward motion to accordingly dispense the harvested crop into each of the first and second grain reservoirs 206, 208. Optionally, the vehicle 116 is driven forward or backward as needed to accordingly move the dispenser 200 and the dispenser nozzle 202 into alignment with each of the first and second grain reservoirs 206, 208 to accordingly fill the grain hauler 204.

As will be described herein, in an example one or more of the harvester 100 and the vehicle 116 include a target designating system (e.g., systems 400, 500 as described herein) configured to provide automated actuation of the dispenser, such as the dispensers 106, 200 shown in FIGS. 1 and 2, to automatically direct the flow of the harvested crop 112 into the corresponding dispensing target such as the grain cart 114 or grain hauler 204. Further, the systems 400, 500 described herein facilitate the precise targeting of zones (flow targets) within the dispensing targets to ensure complete filling of the targets without spilling.

As will be described herein, in one example a target designator is provided including a dispensing target display and a designator reticle movable within the dispensing target display. In one example, the dispensing target display includes a representation of the dispensing target for instance a plan view of one or more of the grain cart 114 and the grain hauler 204. The operator is able to move the designator reticle (e.g., by one or more controls, touchscreen interaction or the like) to a desired flow target on the representation. The location of the designator reticle is indexed to a corresponding location of the dispensing target, for instance a corresponding location in one of the grain cart 114 or the grain hauler 204. A targeting controller of the target designating system 400, 500 indexes the designator location on the dispensing target display to a corresponding location of the dispensing target. An actuator control module of the targeting controller actuates the dispenser (dispenser 106 or dispenser 200) by way of one or more of the actuator mechanisms previously described herein. For instance, a targeting actuator of the dispenser 106 including actuators associated with the dispenser nozzle 108 is operated to accordingly direct the flow of the harvested crop 112 at the flow target corresponding to the designated location of the designator reticle in the dispensing target display. In a similar manner, the dispenser nozzle 202 of the grain cart 114 is similarly operated (actuated) by the actuator control module to accordingly direct the flow of the harvested crop 112 toward one or more of the first or second grain reservoirs 206, 208 (or more discrete locations within the reservoirs) by way of the indexed designator reticle location corresponding to a flow target within the dispensing target for instance the grain hauler 204.

In another example, and as previously described herein, the dispensers 106, 200 shown in FIGS. 1 and 2, respectively, include one or more actuator mechanisms associated with the bases of the dispensers 106, 200. The target designating systems 400, 500 operate these actuators to swing the dispenser arms 106, 200 forward or backward (or in any degree of freedom provided by the actuator mechanism) to direct the flow of the harvested crop 112 at the flow target generated with the designator reticle positioned in the dispensing target display.

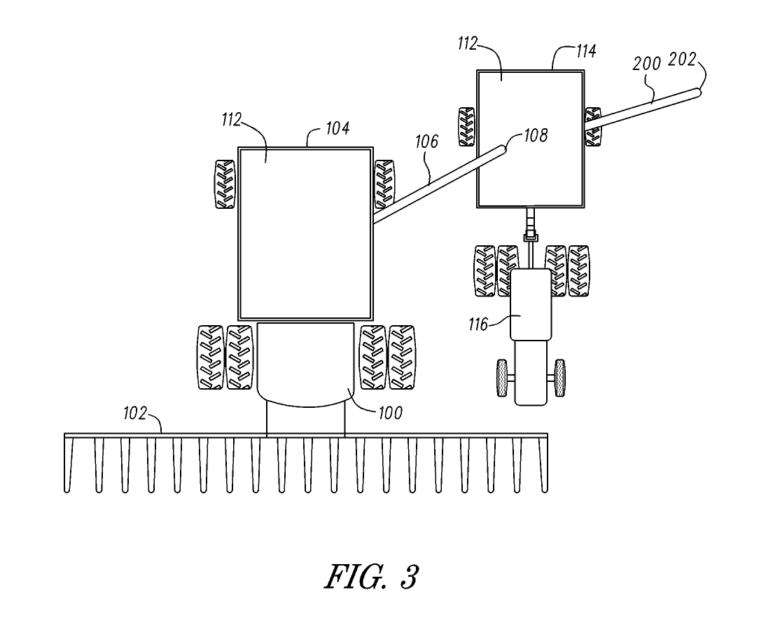

FIG. 3 is a schematic view of the arrangement of vehicles provided in FIG. 1. For instance, the harvester 100 is adjacent to the grain cart 114 pulled by the vehicle 116. As further shown in FIG. 3, the dispenser 106 extends toward the grain cart 114. The dispenser 106 includes an actuator, such as a dispenser nozzle 108, configured to orient the dispenser nozzle 108 in one or more directions relative to the grain cart 114. The operator controls the orientation of the dispenser nozzle 108 and the corresponding direction of flow of the harvested crop 112 into the grain cart 114 to prevent spilling of the harvested crop while at the same time filling the entirety or near entirety of the grain cart 114.

As described herein, a target designating system 400, 500 allows for directing of the dispenser 106 (or other tool as described herein) toward a desired flow target within the dispensing target such as the grain cart 114 or a grain hauler 204. As will be described in one example, the operator (of the harvester 100 in an example) uses a target designator 406 having a target display and a designator reticle positioned on the target display. The operator is able to position the designator reticle 410 on the target display to automatically control the orientation of the dispenser 106 and the dispenser nozzle 108 relative to a desired zone or area of the dispensing target.

As further described herein, the target designating system (e.g., systems 400, 500) in another example is able to automatically adjust for relative movement between the harvester 100 and the dispensing target, for instance the grain cart 114. In a dynamic environment as the harvester 100 is moving in a field (to harvest the harvested crop 112) the vehicle 116 and the grain cart 114 move relative to the harvester 100 (e.g., because of variations in terrain, mismatched speeds or direction of travel or the like). The target designating system 400, 500 described herein is measures the relative movement between the harvester 100 (e.g., the dispenser 106 or the dispenser nozzle 108 of the harvester) relative to the grain cart 114. The target designating systems 400, 500 adjust the orientation of the dispenser nozzle 108 (or in another example, a dispenser 106 including a swing arm actuator) to direct the flow of the harvested crop 112 to the updated position of the flow target within the relatively moving dispensing target, such as the grain cart 114.

Although the previously described examples, including for instance the dispenser 106, describe one example dispenser such as a grain auger with a dispenser nozzle 108, in another example the target designating systems 400, 500 are used with one or more tools including a dispenser such as a grain dispenser, a foam dispenser (e.g., for firefighting foam), liquid dispensers (for water), instruments (optical instruments, cameras, diagnostic tools or like) and weapon systems. For instance, the target designating systems 400, 500 are readily used with one or more of these tools to accordingly orient the tools relative to a desired target shown on a target display and located for instance with a designator reticle positioned over the target on the target display.

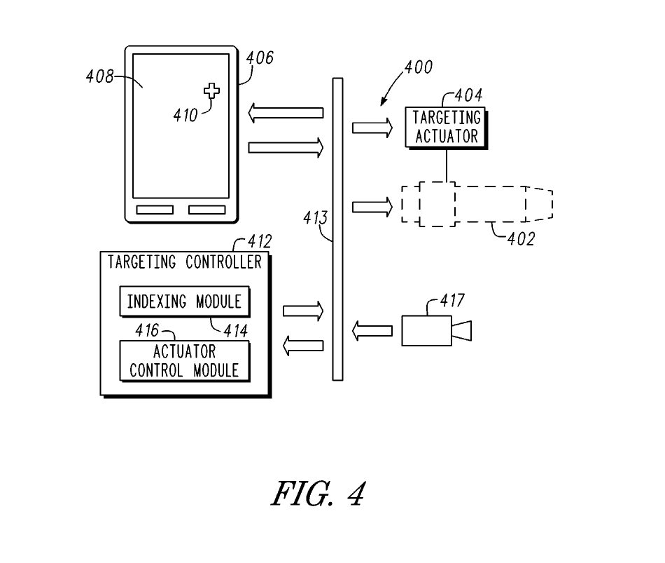

FIG. 4 shows a schematic of one example of a target designating system 400. In the example shown in FIG. 4, the target designating system 400 is configured for use with a tool 402. In one example, the tool 402 includes, but is not limited to, one or more of a dispenser, sensor, instrument, weapon system or the like. For instance, the tool includes any sort of directional instrument, dispenser, weapon or the like that benefits from orientation toward a desired target, target zone (region, area, direction or the like). As further shown in FIG. 4, the target designating system 400 includes in one example a targeting actuator 404 coupled with the tool 402. Optionally, where the target designating system 400 is provided separately from a vehicle or system (e.g., separate to the harvester 100 or a dispenser 200 of the grain cart 114) the target designating system 400 includes a targeting actuator interface (also shown as the targeting actuator 404) configured for coupling with an actuator, for instance with the dispenser nozzle 108 of the dispenser 106 or the dispenser nozzle 202 of the dispenser 200 (as shown in FIGS. 1 and 2, respectively). In another example, where the targeting actuator interface is provided for use with one or more other tools for instance a sensor, instrument or weapon system the targeting actuator interface is configured for coupling (communication) with one or more orientation systems including, but not limited to, one or more actuators or the like for the respective tool.

Referring again to FIG. 4, the target designating system 400 includes a target designator 406 including a target display 408. As previously described herein, in one example the target display 408 provides a representation of the target. As further shown in FIG. 4, a target monitor 417 communicates with the target designator 406 to provide an image or representation of the target on the target display 408. As further shown, the target designator 406 in another example includes a designator reticle 410. Optionally, the target designator 406 is housed in a touchscreen laptop, smartphone, tablet, field computer or the like having a touchscreen configured to allow for operator movement of the designator reticle 410 by touch interaction with the target display 408. Accordingly the operator may, by way of pressing the target display 408 and dragging the finger across the target display 408. move the designator reticle 410 to a desired position of the representation of the target on the target display 408.

The target designating system 400 further includes a targeting controller 412. In one example, the targeting controller 412 is incorporated with the target designator 406 and is accordingly provided in a software package, computer readable media or other system included with the target designator 406. For instance, the targeting controller 412 is a module or subsystem provided as an application on a tablet, smartphone or the like. In another example the targeting controller 412 is an application or program provided on a laptop, field computer or the like (and optionally provided with the harvester 100). Optionally, each of the targeting controller and the target designator are provided in a dedicated device including but not limited to a touchscreen controller configured for interfacing with the remainder of the target designating system 400.

As shown in FIG. 4, the targeting controller 412 includes one or more modules including an indexing module 414 and an actuator control module 416. The indexing module 414 indexes the location of the designator reticle 410 on the target display 408 to a corresponding location on the representation of the target. The indexing module 414 processes the location of the designator reticle and indexes the location of the designator reticle to a corresponding target location (e.g., flow target) on the actual dispensing target (e.g., the grain cart 114 shown in FIG. 1 or the grain hauler 204 shown in FIG. 2). The actuator control module 416 uses the indexed location to accordingly operate the targeting actuator 404 and move the tool 402 (e.g., a dispenser) to direct the tool toward the designated target. One example of calibration of the system 400 (e.g., according to range of motion and to graduate orientation of the tool 402 relative to designator reticle 410 position is provided herein).

As further shown in FIG. 4, the components of the target designating system 400 including the target designator 406, the targeting controller 412, the targeting actuator 404 (or targeting actuator interface) as well as the target monitor 417 communicate with each other by with an interface 413. In one example, the interface 413 includes a bus or CAN bus of one of a vehicle such as the harvester 100 or vehicle 116 shown in FIG. 1. In another example, the interface 413 includes one or more wireless interfaces (RF, Bluetooth or the like) that allow for communication of information between each of the components of the target designating system 400 to accurately control the targeting actuator 404 and thereby direct the tool 402 toward a desired target.

The target monitor 417 includes one or more instruments configured to provide a view of a desired target, target zone or the like (e.g., in the instance of a dispenser, a dispensing target). The target monitor 417 includes in at least one example a video camera providing an ongoing view of the target (e.g., the dispensing target) that thereby allows for real time association of the designator reticle 410 to a desired location on the target for by way of the target display 408 having a representation of the target thereon. In another example, the target monitor 417 includes, but is not limited to, a camera that provides one or more still images to the target designator 406. In one example, the target monitor 417 provides still images of the target at a set interval to allow for updated representations of the target on the target display 408. Optionally, the targeting controller 412 operates the target monitor 417, such as a camera, to capture an updated still image when relative motion is detected between the target (e.g., a grain cart 114) and the tool. Relative motion is optionally detected and measured as described herein.

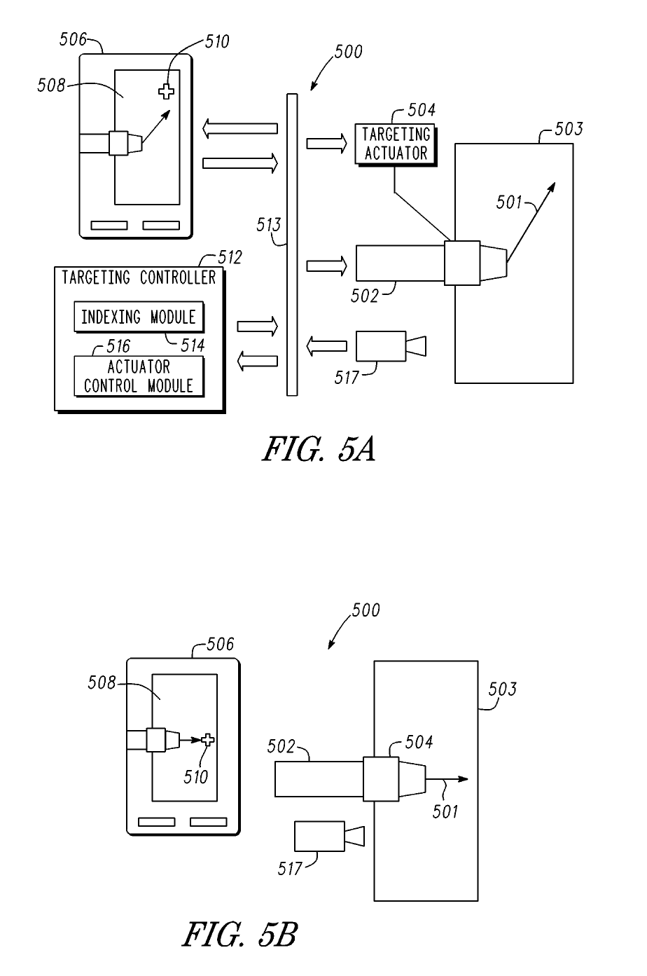

FIG. 5A shows another example of a target designating system including the target designating dispensing system 500. As shown in FIG. 5A, the target designating dispensing system 500 includes one or more components similar to the target designating system 400 previously described herein and shown in FIG. 4. For instance, the system 500 includes a targeting actuator 504 or target actuating interface configured for coupling with a dispenser such as the dispenser 502 (e.g., a tool). The targeting actuator 504 is in turn in communication by way of an interface 513 with a target designator 506 as well as a targeting controller 512. Additionally, as shown in FIG. 5A, a target monitor 517 is shown in communication with the target designating dispensing system 500. As with the example system 400 shown in FIG. 4, the target monitor 517 includes but is not limited to one or more of a video camera, camera or the like. In one example, the target monitor 517 is coupled with the dispenser 502 for instance the target monitor 517 is provided on the dispenser 502 and coupled for instance near the dispenser nozzle of the dispenser 502 (e.g., corresponding to one or more of the dispenser nozzles 108, 202 shown in FIGS. 1 and 2). In another example, the target monitor 517 is coupled with the dispenser 502 (on a vehicle coupled with the dispenser 502) for instance at a location near to the dispenser 502 and directed toward a dispensing target such as the dispensing target 503 shown in FIG. 5A.

Referring again to FIG. 5A, the dispensing target 503 is shown in a representation (as a corresponding rectangle) in the target display 508 of the target designator 506. As shown in the example, the target display 508 includes a graphical representation of dispenser 502 as well as the dispensing target 503. Also shown in FIG. 5A is a designator reticle 510 on the target display 508 for instance overlaid relative to the representation of the dispensing target 503. As further shown in FIG. 5A, the target designator 506 is in communication interface 513 with the targeting controller 512 with the interface 513. The targeting controller 512 includes one or more of an indexing module 514 and an actuator control module 516 similar in at least some regards to the modules of the targeting controller 412 shown in FIG. 4 and previously described herein.

Referring again to FIG. 5A, in operation the target monitor 517 provides an image or real time display of the dispensing target 503 on the target display 508. The operator (e.g., of the harvester 100 or vehicle 116) moves the designator reticle 510 to a desired location of the representation of the dispensing target 503. As shown in FIG. 5A, the designator reticle 510 is moved to a top right corner of the dispensing target 503. The target designator 506 relays this information with the interface 513 (e.g., a bus, CAN bus, wireless connection or the like) to the targeting controller 512. The indexing module 514 indexes the location of the designator reticle 510 on the target display 508 to a corresponding location of the dispensing target 503. The indexed location of the designator reticle 510 is thereby equated to a flow target for the dispenser 502 in the dispensing target 503.

The actuator control module 516 uses the indexed location to provide instructions to the targeting actuator interface coupled for instance with a targeting actuator 504 as shown in FIG. 5A. In one example, the dispenser 502 includes the targeting actuator 504 near the dispenser nozzle such as the dispenser nozzles 108, 202 shown for instance in FIGS. 1 and 2. In another example, the targeting actuator 504 is provided at the base of one or more of the dispensers 106, 200 for instance by way of one or more swing actuators configured to move the dispenser 106, 200 in a backwards or forwards direction or in another example telescope the dispenser 106, 200 relative to the grain cart 114 or grain hauler 204. The instructions from the actuator control module 516 received by the targeting actuator 504 orient the dispenser 502 (e.g., the dispenser nozzle) relative to the dispensing target 503. The harvested crop stream 501 shown in FIG. 5A is directed toward a flow target in the dispensing target 503 (in this example the top right corner) corresponding to the location of the designator reticle 510 as positioned on the target display 508. That is to say, as the operator moves the designator reticle 510 to a desired location on the target display 508 the targeting controller 512 interprets the movement of the designator reticle 510 and its location to a corresponding portion of the dispensing target 503. In the example shown in FIG. 5A, the positioning of the designator reticle 510 at a top right portion of the displayed version of the dispensing target 503 on the target display 508 correspondingly directs the harvested crop stream 501 toward the equivalent location of the dispensing target 503.

As shown in FIG. 5A, the corresponding location is the top right corner of the dispensing target 503. As further shown herein, the operator moves the designator reticle 510 as desired to accordingly move the corresponding flow target of the dispenser 502 to another portion of the dispensing target 503. Complex control, for instance including directional arrow buttons, joystick actuation or the like otherwise provided at one or more of the harvester 100 or the vehicle 116 are thereby avoided. Instead, the user with a touchscreen interface or other graphical interface moves the designator reticle 510 to a corresponding location of the representative dispensing target 503. The targeting actuator 504 operated by the targeting controller 512 (optionally incorporated with the target designator 506) to orient the dispenser 502 and direct the dispenser 502 (e.g., a harvested crop stream 501) toward the desired location in the dispensing target 503. Complex and tedious manipulation of the dispenser 502 to achieve a desired flow target for the dispenser 502 is thereby avoided. Instead, the user quickly and readily moves a designator reticle 510 to a desired location of a representation of the dispensing target 503 and the target designating and dispensing system 500 quickly and efficiently directs the dispenser 502 and the harvested crop stream 501 toward the desired location in the dispensing target 503.

In another example, the target designating dispensing system 500 (or system 400) is calibrated, for instance at installation of the system or during production of a vehicle (e.g., the harvester 100 or vehicle 116). Optionally, a designation instrument, such as a laser designator, is coupled with the tool, such as the dispenser 502. In one example, the designation instrument is coupled with a nozzle of the dispenser 502 that delivers the harvested crop stream 501.

The dispenser 502 is traversed within its range of motion and an operation zone is marked off during the traversal. For example, the dispenser 502 is traversed (e.g., by the targeting actuator 504) to the borders of the targeting actuator range of motion. In one example, the borders of the range of motion of the targeting actuator 504 correspond to the range of motion for one or more of roll/pitch or azimuth/elevation of the targeting actuator 504. The designation instrument presents an indicia (e.g., a laser dot or the like) that tracks with movement of the dispenser 502. At each of the borders for the range of motion the operator interacts with the target display 508 of the target designator 506. For instance, the operator positions the designator reticle 510 at the location on the target display 508 presenting the indicia provided by the designation instrument (e.g., as viewed by the targeting monitor 517). This operation is repeated to calibrate for the operational area for the dispenser 502. The targeting controller 512 (or 412) corresponds the operational area of the dispenser to Cartesian coordinates on the target display 508. Further the targeting controller 512 (or 412) graduates orientation of the dispenser 502 according to the calibrated operational area. Accordingly after calibration, operator interaction with the targeting display 508, for instance to move the designator reticle 510 to a location (Cartesian coordinates) within the operational area of the dispenser 520, generates corresponding orientation (roll/pitch or azimuth/elevation) of the dispenser 502 toward that location (e.g., in the dispensing target 503) through the targeting controller 512.

FIG. 5B shows another example of the target designating dispensing system 500. In the example view shown in FIG. 5B the designator reticle 510 is moved on the target display 508 to an updated location relative to the location provided in FIG. 5A. For instance, as shown in FIG. 5B the designator reticle 510 is moved to an intermediate location between the top and bottom of the dispensing target 503. As with the example shown in FIG. 5A, the updated location of the designator reticle 510 is conveyed from the target designator 506, for instance by way of the interface 513, to the targeting controller 512 (see FIG. 5A). The targeting controller 512 including the indexing module 514 indexes the location of the designator reticle 510 to the corresponding location of the dispensing target 503. The indexed location is used by the actuator control module 516 (also shown in FIG. 5A) to provide instructions (actuator commands) to the targeting actuator 504 associated with the dispenser 502. In one example, the instructions are provided through a target actuator interface coupled with the targeting actuator 504. For instance the target actuating interface includes one or more plugs including a multi-prong plug or other data interface configured to provide a variety of control signals to the targeting actuator 504 to orient the dispenser 502 and the harvested crop stream 501 toward the desired flow target.

Referring again to FIG. 5B, as the instructions are provided to the targeting actuator 504 for instance from the targeting controller 512 the targeting actuator 504 orients the dispenser 502 (e.g., one or more of the dispenser nozzles 108, 202 shown in FIGS. 1 and 2) to the updated flow target of the dispensing target 503. For instance, with the designator reticle 510 positioned at the location on the target display 508 the harvested crop stream 501 is directed toward a corresponding portion of the dispensing target 503. The reorientation of the dispenser 502 by operation of the targeting actuator 504 is automatically initiated by movement of the designator reticle 510 (e.g., by touch interface) over the target display 508. The targeting controller 512 (as preciously described herein) interprets the indexed location of the designator reticle 510 and automatically generates commands by way of the actuator control module 516 to operate the targeting actuator 504 and redirect the dispenser 502 to the updated location on the dispensing target 503 corresponding with the location of the designator reticle 510 on the target display 508.

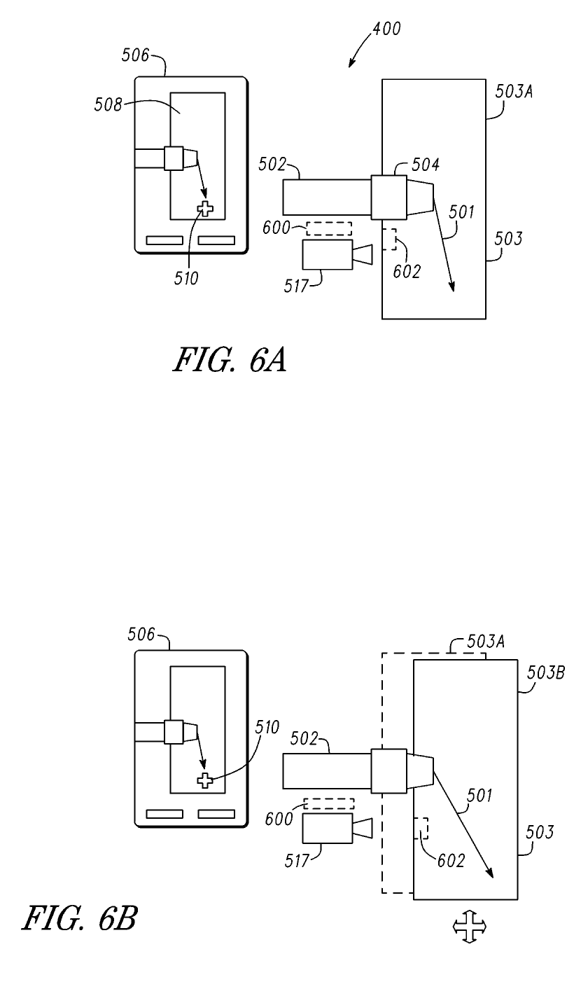

FIG. 6A shows another example of the target designating dispensing system 500 with the designator reticle 510 positioned at a third location relative to the views shown in FIGS. 5A, B. As shown, the designator reticle 510 is provided at a bottom portion of the target display 508 of the target designator 506. As previously described, herein the target display 508 includes a representation of the dispensing target 503. The position of the designator reticle 510 at the location provided in the target display 508 is indexed by the indexing module 514 of the targeting controller 512 (shown in FIG. 5A) to thereby provide a corresponding flow target location on the dispensing target 503A for the dispenser 502. Accordingly, with repositioning of the designator reticle 510 by the operator to the third location the actuator control module 516 uses the indexed location from the indexing module 514 to generate one or more instructions to the targeting actuator 504 for operation of the dispenser 502 (e.g., the targeting actuator 504 including one or more actuators) to reorient the dispenser 502 and the harvest crop stream 501 toward a flow target on the dispensing target 503A corresponding to the location of the designator reticle 510.

As further shown in both FIGS. 6A and 6B, the dispensing target 503 is shown in two locations, for instance a first dispensing target location 503A and a second dispensing target location 503B (as shown in FIG. 6B). In another example, the target designating dispensing system 500 includes one or more instruments, features or the like configured to measure the relative movement of the dispensing target 503 relative to one or more of the dispenser 502, a motion sensor 600 or the like. Referring to FIG. 6B, the dispensing target 503 is shown in a second location 503B relative to the first location 503A (shown in dash lines).

In one example, the target designating dispensing system 500 measures relative movement between the dispenser 502 and the dispensing target 503 with the target monitor 517. For instance, the target monitor 517 in cooperates with the targeting controller 512 and measures relative movement of the dispensing target 503 from an initial position taken at the time the designator reticle 510 is moved to its most recent position (e.g., for instance the bottom position location of the designator reticle 510 FIG. 6A). The targeting controller 512 processes the views of the dispensing target 503 at that time (e.g., 503A) and at a later time (e.g., 503B with movement of the target) to compare the position of the dispensing target 503B with the position of the target 503A. If the determined position change is more than a threshold amount (e.g., one inch or more, 6 inches or more, a foot or more or the like in one or more directions) the targeting controller 512 forwards the measured relative movement value (position change) to the actuator control module 516 to reorient the dispenser 502 to the updated (moved) location. The measured movement is optionally divided into component movement, for instance by way of Cartesian vectors for use by the actuator control module 516 to operate the targeting actuator 504.

In another example, the target designating dispensing system 500 includes a motion sensor 600 coupled with one or more of the dispenser 502, the target monitor 517 or another fixed portion of a vehicle, such as the harvester 100 or the vehicle 116. The motion sensor 600 in one example is a dedicated sensor configured to measure the movement of the dispensing target 503 and provide the measured movement of the dispensing target 503 to the targeting controller 512 (e.g., as Cartesian vectors) to accordingly operate the targeting actuator 504 to reorient the dispenser 502 and account for movement of the dispensing target 503 (e.g., from 503A to 503B). Reorientation of the dispenser 502 automatically based on relative movement accordingly ensures continued accurate direction of the dispenser 502 toward a desired flow target, for instance a flow target corresponding to the originally located designator reticle 510 shown in FIGS. 6A, B.

In another example, the motion sensor 600 is paired with a reference location 602. In one example, the reference location 602 is provided on the dispensing target 503. The reference location 602 includes, but is not limited to, a fiducial marker provided on the dispensing target 503. The motion sensor 600 in one example is operated by the targeting controller 512 to identify the reference location 602 and measure relative motion of the reference location 602 relative to the motion sensor 600. The motion sensor 600 includes, but is not limited to, one or more of the target monitor 517, an image processor coupled with the target monitor or another sensor, an infrared sensor, an ultrasonic sensor, a near field sensor, a magnetic sensor or a radio frequency sensor. In one or more of these examples, the motion sensor 600 includes a dedicated reference location 602 including one or more types of fiducial markers, such as an RFID tag, magnetic tag or the like configured to provide ready recognition by the motion sensor 600 and thereby readily measure the relative movement of the reference location 602 and the dispensing target 503 relative to the dispenser 502.

In operation, the motion sensor 600 (separate from or incorporated with the target monitor 517) measures the movement of the dispensing target 503. In one example, the motion sensor 600 detects movement of the reference location 602, such as a fiducial marker. The detected movement by the motion sensor 600 is provided to movement modules including for instance the targeting controller 512 shown in FIG. 5A. The targeting controller 512 determines the relative movement between the tool (e.g., the dispenser 502) and one or more of the dispensing target 503 or flow target for instance a location corresponding to the designator reticle 510 on the target display 508. In one example, for instance, the motion sensor 600 detects relative movement of a reference location 602 (corresponding to the location of the dispensing target 503). The measurement of the position of the reference location 602 is used by the targeting controller 512 to accordingly provide a monitored ongoing determination of the change in position of the dispensing target 503 relative to an original position of the dispensing target 503, for instance taken at the time of the positioning of the designator reticle 510 at the position shown in FIG. 6A.

The measured movement between the first and second locations 503A, 503B is used by the actuator control module 516 to accordingly provide supplemental instructions for operation or articulation of the targeting actuator 504. The targeting actuator 504 is operated to reorient the dispenser 502 and the harvested crop stream 501 to ensure continued delivery of the harvested crop to the location designated with the designator reticle 510 (FIG. 6A) with the dispensing target 503A, B in both positions shown in FIGS. 6A, B. Optionally, and as discussed herein, the measured movement of the dispensing target (as shown by 503A, B) triggers reorientation by the targeting controller 512 and the targeting actuator 504 when the measured movement is greater than or equal to a movement threshold including, but not limited to, movement in one or more directions of 1 inch or greater, 6 inches or greater, 12 inches or greater or the like.

As shown in FIGS. 6A, B, the harvested crop stream 501 changes orientation relative to the dispenser 502 and the dispensing target 503 while the end location for the harvested crop stream 501 remains substantially equivalent to the location of the designator reticle 510 as shown on the target designator 506. That is to say, even with shifting of the dispensing target 503B relative to a first location 503A, the dispenser 502 automatically updates the articulation of the targeting actuator 504 to accordingly ensure continued delivery of the harvested crop stream 501 to the desired flow target. Stated another way, after designation of a location for the designator reticle 510 as shown for instance in FIG. 6A the corresponding flow target of the dispenser 502 remains the same even with motion of the dispensing target 503 after positioning of the designator reticle 510. The operator of a vehicle (e.g., the harvester 100 or the vehicle 116) is able to continue operation of the vehicle without continually or in an ongoing fashion readjusting positioning of the designator reticle 510 to account for movement of the dispensing target 503 relative to the dispenser 502.

In another example, the targeting controller 512 includes a prohibition module that precludes orientation of the dispenser 502 and corresponding direction of the harvested crop stream 501 toward a flow target outside of the dispensing target 503. The prohibition module processes images or video (e.g., taken by the targeting monitor 517) and identifies blocked regions of images or the video feed that are outside of the dispensing target 503. Positioning of the designator reticle 510 within one of the regions outside of the dispensing target 503 triggers the prohibition module to preclude orientation of the dispenser 502 toward the corresponding location (e.g., even if the location is within the range of motion of the targeting actuator 504).

The targeting controller 512 (e.g., the prohibition module) identifies blocked regions with one or more operations. In one example, the targeting controller 512 processes images or the video feed from the targeting monitor 517 and identifies differences in movement between the dispensing target 503 and the surrounding terrain. For instance, where the dispensing target 503 includes a moving target such as a grain cart 114 the targeting controller 512 identifies regions of the image or video feed that move at a relatively greater speed than other regions and assigns the faster moving regions as blocked regions (e.g., the cart 114 is moving at a speed relatively similar to the harvester 100 and appears static or slow while the surrounding terrain appears to be moving faster). In another example, the targeting controller 512 conducts a color evaluation of the image or video feed and assigns blocked regions to regions that are within or outside of a specified color scheme. For instance, in a color scheme including earth tones the targeting controller 512 assigns blocked regions to portions of images or a video feed that include earth tones (e.g., the field including soil). Optionally, in a color scheme including equipment color schemes (e.g., green, red, aluminum coloring or the like) the targeting controller 512 assigns blocked regions to portions of images or a video feed that do not include the colors of the equipment color schemes. In still other examples, the targeting controller 512 includes one or more of edge identification, shape identification and color identification algorithms that facilitate the identification of the dispensing target 503 and corresponding assignment of other portions of images or a video feed as blocked regions. The targeting controller 512 (e.g., the prohibition module) optionally updates the blocked regions as the system 500 operates. Positioning of the designator reticle 510 within a location corresponding to a blocked region precludes the orientation of the dispenser 502 toward the location. Optionally, the targeting controller 512 allows orientation of the dispenser 502 (e.g., by the actuator control module 516) to the edge of the dispensing target 503 adjacent to the blocked location and precludes further movement of the dispenser 502 toward the blocked location.

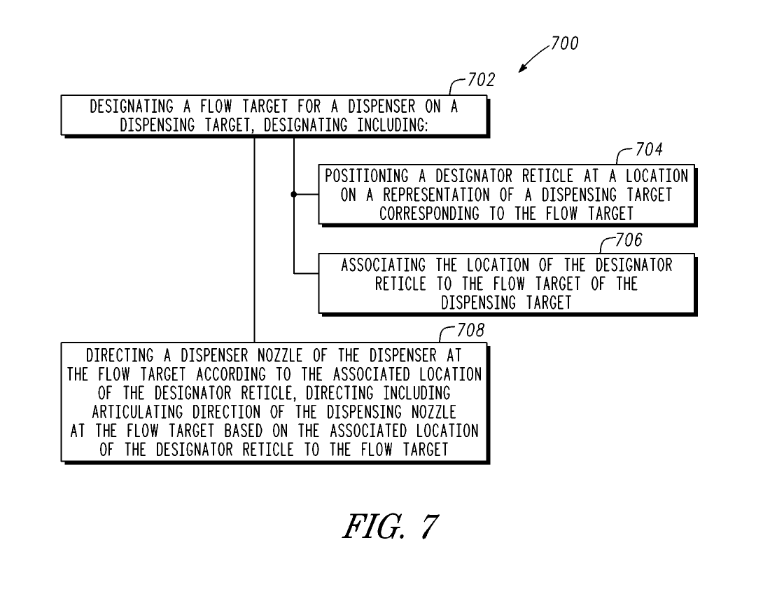

FIG. 7 shows one example of a method 700 for directing a dispenser to a flow target. In describing the method 700 reference is made to one or more components, features, functions and steps previously described herein. Where convenient, reference is made to the components, features, steps and the like with reference numerals. Reference numerals provided are exemplary and are nonexclusive. For instance, components, features, functions, steps and the like described in the method 700 include, but are not limited to, the corresponding numbered elements provided herein, other corresponding features described herein (both numbered and unnumbered) as well as their equivalents.

At 702, the method 700 includes designating a flow target for a dispenser such as the dispenser 502 (shown in FIG. 5A, or a tool 402 as shown in FIG. 4) on a dispensing target 503. In one example, designating the flow target includes interacting with a target designator 506 as described previously described herein. For instance, at 704 a designator reticle 510 is positioned at a location corresponding to the desired flow target on a representation of a dispensing target 503. In one example, positioning of the designator reticle 510 includes interaction with a touch screen such as the target display 508 shown in FIG. 5A. The operator moves the designator reticle 510 by tactile manipulation of the target display 508.

At 706, the location of the designator reticle 510 is associated to the flow target on the dispensing target 503. As described herein, in one example a targeting controller 512 includes an indexing module 514. The indexing module 514 indexes the location of the designator reticle 510 to a corresponding portion of the dispensing target 503 for instance the desired flow target within the dispensing target 503.

At 708, the method 700 includes directing a dispenser nozzle (e.g., dispenser 502 or tool 402) at the flow target according to the associated location of the designator reticle 510. Directing includes articulating the direction (orientation) of the dispenser nozzle 502 at the flow target based on the associated location of the designator reticle 510 to the flow target (as performed in one example by the indexing module 514 of the targeting controller 512).

Several options for the method 700 follow. In one example, positioning the designator reticle 510 includes using touch interaction with the target display 508 of the target designator 506 to position the designator reticle 510 at the location corresponding to a desired flow target in the dispensing target 503. In another example, the method 700 further includes generating the representation of the dispensing target 503. Optionally, generating the representation of the dispensing target includes viewing the dispensing target 503 with a target monitor 517 (e.g., shown in FIGS. 5A, 5B and 6A, 6B). As previously described herein, the target monitor 517 includes, but is not limited to, one or more of a video camera, still image camera or the like. In another example, the representation of the dispensing target 503 is a graphical representation of the dispensing target for instance corresponding to a target zone or region. In such an example, the representation of the dispensing target on the target display 508 is a graphical representation and not a real time representation.

In still another example, the method 700 includes repeating designation of the flow target and directing the dispenser nozzle 502 at the flow target according to positioning of the designator reticle 510 at a second location on the representation of the dispensing target (shown on the target display 508) corresponding to a second flow target. The second location and the second flow target are different from the first location and the first flow target. For instance, as shown in FIG. 5A a first location of the designator reticle 510 corresponds to a first flow target shown by way of the harvested crop stream 501 directed to the upper right corner of the dispensing target 503. Conversely, an exemplary second location of the designator reticle 510 is shown in FIG. 5B with the designator reticle 510 positioned near to a mid-point of the representation of the dispensing target 503. As further shown in FIG. 5B, the second flow target is provided at the mid-point of the dispensing target 503 and thereby corresponds to the second updated location of the designator reticle 510.

In another example, directing the dispenser nozzle at the flow target according to the associated location of the designator reticle 510 includes maintaining direction of the dispenser nozzle 502 at the flow target with relative movement of one or more of the dispensing target or the flow target relative to the dispenser 502. For instance as previously described herein, one or more of the target monitor 517, motion sensor 600 or the like is used in combination with relative movement of the dispensing target 503 (e.g., from a first location 503A to a second location 503B) to accordingly measure movement of the dispensing target 503 or flow target and thereby adjust articulation of the dispensers 502 (or tool 402) to maintain direction of the dispenser 502 at the desired flow target. In one example, maintaining direction of the dispenser nozzle 502 at the flow target with relative movement includes measuring movement of one or more of the dispensing target or the flow target relative to the dispenser 502.

As previously described herein, in one example, measurement of relative movement of the dispensing target 503 or flow target relative to the dispenser 502 is accomplished with one or more of a motion sensor 600, the target monitor 517 and optionally a reference location 602, such as a fiducial marker. Maintaining the direction of the dispenser nozzle 502 further includes, in another example, further articulating the direction of the dispenser nozzle 502 toward the flow target based on the measured movement. For instance as shown in FIG. 6B, the dispensing target 503 is shown moved between a first location 503A (shown in dashed lines) and a second location 503B (shown in solid lines). As shown, the harvested crop stream 501 is adjusted from the view shown in FIG. 6A to the view shown in FIG. 6B according to the movement of the dispensing target 503. The targeting controller 512 in combination with one or more of the target monitor 517 and motion sensor 600 measures the relative movement of the dispensing target 503 between the first and second locations 503A, 503B and adjusts the articulation of the targeting actuator 504 to accordingly maintain the harvested crop stream 501 at the desired flow target which stays substantially the same between each of FIGS. 6A and 6B.

In still another example, the method 700 includes fixing the location of the flow target relative to the dispenser 502 (e.g., one or more of the motion sensor 600, target monitor 517 or the like) at the associated location of the designator reticle 510 to the flow target in the dispensing target 503 at a first time. Measuring movement of one or more of the dispensing target or the flow target relative to the dispenser 502 includes measuring a current location of the flow target relative to the previously fixed location of the flow target and further articulating the direction of the dispenser 502 (including one or more of the dispenser nozzles 108, 202 or the tool 402 described herein). The dispenser nozzle 502 is further articulated based on the difference between the current and previously fixed locations of the flow target. Stated another way, as the flow target moves for instance between the first and second dispenser locations 503A, 503B the flow target position is measured between an original position for instance at the time of positioning of the designator reticle 510 and at a second time corresponding to a later time with the dispensing target 503 moved relative to a first location 503A. By comparing the location of the flow target between each of these positions a corresponding difference is determined between the locations and the difference is used by the targeting controller 512 to generate instructions for supplemental articulation of the targeting actuator 504 to adjust the harvested crop stream 501 for continued direction at the desired flow target even with movement of the dispensing target 503 and flow target relative to an original position.

### Various Notes & Examples

Example 1 can include subject matter, such as can include a target designating dispensing system comprising: a dispenser including a dispenser nozzle and a targeting actuator coupled with the dispenser nozzle; a target designator including: a dispensing target display, the dispensing target display provides a representation of a dispensing target, and a designator reticle movable in the dispensing target display; a targeting controller in communication with the targeting actuator and the target designator, the targeting controller including: an indexing module, the indexing module associates a location of the designator reticle on the representation of the dispensing target to a flow target on the dispensing target, and a actuator control module, the actuator control module operates the targeting actuator to direct the dispenser nozzle at the flow target.

Example 2 can include, or can optionally be combined with the subject matter of Example 1, to optionally include wherein the actuator control module operates the targeting actuator to maintain direction of the dispenser nozzle at the flow target with relative movement between one or more of the dispensing target or the flow target and the dispenser.

Example 3 can include, or can optionally be combined with the subject matter of one or any combination of Examples 1 or 2 to optionally include a motion sensor coupled with the dispenser, and a reference location coupled with the dispensing target, the motion sensor measures movement of the reference location, wherein the targeting controller measures relative movement between one or more of the dispensing target or the flow target and the dispenser with the motion sensor and the reference location.

Example 4 can include, or can optionally be combined with the subject matter of one or any combination of Examples 1-3 to optionally include wherein the motion sensor includes at least one of a dispensing target monitor and an image processor, an infrared sensor, an ultrasonic sensor, a near field sensor, a magnetic sensor, or a radio frequency sensor.

Example 5 can include, or can optionally be combined with the subject matter of one or any combination of Examples 1-4 to optionally include a dispensing target monitor, the dispensing target monitor is in communication with the target designator and provides the representation of the dispensing target.

Example 6 can include, or can optionally be combined with the subject matter of Examples 1-5 to optionally include wherein the dispensing target monitor communicates movement of one or more of the dispensing target or the flow target relative to the dispenser to the targeting controller, and the actuator control module operates the targeting actuator to maintain direction of the dispenser nozzle at the flow target according to the communicated movement.

Example 7 can include, or can optionally be combined with the subject matter of Examples 1-6 to optionally include wherein the dispensing target monitor is a video camera.

Example 8 can include, or can optionally be combined with the subject matter of Examples 1-7 to optionally include wherein the dispensing target monitor is a camera in communication with the controller, and the controller operates the camera at an interval to capture images, and the controller displays one or more of the captured images on the dispensing target display.

Example 9 can include, or can optionally be combined with the subject matter of Examples 1-8 to optionally include wherein the dispensing target display includes a touch screen, and the designator reticle includes a touch based designator reticle movable with touch interaction with the touch screen.

Example 10 can include, or can optionally be combined with the subject matter of Examples 1-9 to optionally include wherein the target designator and the controller are housed in one of a tablet computer, laptop computer, smartphone, or field computer.

Example 11 can include, or can optionally be combined with the subject matter of Examples 1-10 to optionally include wherein the dispenser includes an auger and the dispenser nozzle is a grain nozzle of the auger.

Example 12 can include, or can optionally be combined with the subject matter of Examples 1-11 to optionally include wherein the dispenser is a liquid dispenser and the dispenser nozzle is a liquid nozzle.

Example 13 can include, or can optionally be combined with the subject matter of Examples 1-12 to optionally include a target designating dispensing system for use with a dispenser having a targeting actuator and a dispenser nozzle, the target designating dispensing system comprising: an targeting actuator interface, the targeting actuator interface couples with the targeting actuator; a target designator including: a dispensing target display, the dispensing target display provides a representation of a dispensing target, and a designator reticle movable in the dispensing target display; a targeting controller in communication with the articulating mechanism interface and the target designator, the targeting controller including: an indexing module, the indexing module associates a location of the designator reticle on the representation of the dispensing target to a flow target on the dispensing target, and a actuator control module, the actuator control module communicates with the targeting actuator interface to direct the dispenser nozzle at the flow target.

Example 14 can include, or can optionally be combined with the subject matter of Examples 1-13 to optionally include wherein the actuator control module communicates with the articulating mechanism to maintain the direction of the dispenser nozzle at the flow target with movement between one or more of the dispensing target or the flow target relative to the dispenser.

Example 15 can include, or can optionally be combined with the subject matter of Examples 1-14 to optionally include a motion sensor coupled with the dispenser, and a reference location coupled with the dispensing target, the motion sensor measures movement of the reference location, wherein the targeting controller measures relative movement between one or more of the dispensing target or the flow target and the dispenser with the motion sensor and the reference location.

Example 16 can include, or can optionally be combined with the subject matter of Examples 1-15 to optionally include the dispenser, the dispenser including: the dispenser nozzle, and the targeting actuator coupled with the dispenser nozzle.

Example 17 can include, or can optionally be combined with the subject matter of Examples 1-16 to optionally include wherein the dispenser includes an auger and the dispenser nozzle is a grain nozzle of the auger.

Example 18 can include, or can optionally be combined with the subject matter of Examples 1-17 to optionally include wherein the dispenser is a liquid dispenser and the dispenser nozzle is a liquid nozzle.

Example 19 can include, or can optionally be combined with the subject matter of Examples 1-18 to optionally include a dispensing target monitor, the dispensing target monitor is in communication with the target designator and provides the representation of the dispensing target.

Example 20 can include, or can optionally be combined with the subject matter of Examples 1-19 to optionally include wherein the dispensing target monitor communicates movement of one or more of the dispensing target or the flow target relative to the dispenser to the targeting controller, and the actuator control module operates the targeting actuator to maintain the direction of the dispenser nozzle at the flow target according to the communicated movement.

Example 21 can include, or can optionally be combined with the subject matter of Examples 1-20 to optionally include wherein the dispensing target display includes a touch screen, and the designator reticle includes a touch based designator reticle movable with touch interaction with the touch screen.

Example 22 can include, or can optionally be combined with the subject matter of Examples 1-21 to optionally include wherein the target designator and the controller are housed in one of a tablet computer, laptop computer, smartphone, or field computer.

Example 23 can include, or can optionally be combined with the subject matter of Examples 1-22 to optionally include a method for directing a dispenser to a flow target comprising: designating a flow target for a dispenser on a dispensing target, designating including: positioning a designator reticle at a location on a representation of a dispensing target corresponding to the flow target, and associating the location of the designator reticle to the flow target on the dispensing target; and directing the dispenser at the flow target according to the associated location of the designator reticle, directing including articulating the direction of the dispenser at the flow target based on the associated location of the designator reticle to the flow target.

Example 24 can include, or can optionally be combined with the subject matter of Examples 1-23 to optionally include wherein directing the dispenser at the flow target according to the associated location of the designator reticle includes maintaining direction of the dispenser at the flow target with relative movement of one or more of the dispensing target or the flow target relative to the dispenser.

Example 25 can include, or can optionally be combined with the subject matter of Examples 1-24 to optionally include wherein maintaining direction of the dispenser at the flow target with relative movement includes: measuring movement of one or more of the dispensing target or the flow target relative to the dispenser, and further articulating the direction of the dispenser toward the flow target based on the measured movement.

Example 26 can include, or can optionally be combined with the subject matter of Examples 1-25 to optionally include fixing the location of the flow target relative to the dispenser at the associated location of the designator reticle to the flow target.

Example 27 can include, or can optionally be combined with the subject matter of Examples 1-26 to optionally include wherein measuring movement of one or more of the dispensing target or the flow target relative to the dispenser includes: measuring a current location of the flow target relative to the previously fixed location of the flow target, and further articulating the direction of the dispenser toward the flow target based on the difference between the current and previously fixed locations of the flow target.

Example 28 can include, or can optionally be combined with the subject matter of Examples 1-27 to optionally include wherein positioning the designator reticle includes using touch interaction with a screen to position the designator reticle at the location.

Example 29 can include, or can optionally be combined with the subject matter of Examples 1-28 to optionally include generating the representation of the dispensing target, wherein generating the representation of the dispensing target includes viewing the dispensing target with a dispensing target monitor.

Example 30 can include, or can optionally be combined with the subject matter of Examples 1-29 to optionally include repeating designating the flow target and directing the dispenser at the flow target according to positioning the designator reticle at a second location on the representation of the dispensing target corresponding to a second flow target, the second location and second flow target different from the location and the flow target.

Each of these non-limiting examples can stand on its own, or can be combined in any permutation or combination with any one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A target designating dispensing system comprising:
a dispenser including a dispenser nozzle and a targeting actuator coupled with the dispenser nozzle;
a target designator including:
a dispensing target display, the dispensing target display provides a representation of a dispensing target, and
a designator reticle movable in the dispensing target display;
a targeting controller in communication with the targeting actuator and the target designator, the targeting controller includes:
an indexing module, the indexing module associates a location of the designator reticle on the representation of the dispensing target to a flow target on the dispensing target, and
an actuator control module, the actuator control module operates the targeting actuator to direct the dispenser nozzle at the flow target.

2. The target designating dispensing system of claim 1, wherein the actuator control module operates the targeting actuator to maintain direction of the dispenser nozzle at the flow target with relative movement between the dispenser and one or more of the dispensing target or the flow target.

3. The target designating dispensing system of claim 2 comprising:
a motion sensor coupled with the dispenser, and
a reference location coupled with the dispensing target, the motion sensor measures movement of the reference location, wherein the targeting controller measures relative movement between the dispenser and one or more of the dispensing target or the flow target with the motion sensor and the reference location.

4. The target designating dispensing system of claim 3, wherein the motion sensor includes at least one of a dispensing target monitor and an image processor, an infrared sensor, an ultrasonic sensor, a near field sensor, a magnetic sensor, or a radio frequency sensor.

5. The target designating dispensing system of claim 1 comprising a dispensing target monitor, the dispensing target monitor is in communication with the target designator and provides the representation of the dispensing target.

6. The target designating dispensing system of claim 5, wherein the dispensing target monitor communicates movement of one or more of the dispensing target or the flow target relative to the dispenser to the targeting controller, and the actuator control module operates the targeting actuator to maintain direction of the dispenser nozzle at the flow target according to the communicated movement.

7. The target designating dispensing system of claim 5, wherein the dispensing target monitor is a video camera.

8. The target designating dispensing system of claim 5, wherein the dispensing target monitor is a camera in communication with the controller, and the controller operates the camera at an interval to capture images, and the controller displays one or more of the captured images on the dispensing target display.

9. The target designating dispensing system of claim 1, wherein the dispensing target display includes a touch screen, and the designator reticle includes a touch based designator reticle movable with touch interaction with the touch screen.

10. The target designating dispensing system of claim 1, wherein the target designator and the targeting controller are housed in one of a tablet computer, laptop computer, smartphone, or field computer.

11. The target designating dispensing system of claim 1, wherein the dispenser includes an auger and the dispenser nozzle is a grain nozzle of the auger.

12. The target designating dispensing system of claim 1, wherein the dispenser is a liquid dispenser and the dispenser nozzle is a liquid nozzle.

13. A target designating dispensing system for use with a dispenser having a targeting actuator and a dispenser nozzle, the target designating dispensing system comprising:
an targeting actuator interface, the targeting actuator interface couples with the targeting actuator;
a target designator including:
a dispensing target display, the dispensing target display provides a representation of a dispensing target, and
a designator reticle movable in the dispensing target display;
a targeting controller in communication with the articulating mechanism interface and the target designator, the targeting controller including:
an indexing module, the indexing module associates a location of the designator reticle on the representation of the dispensing target to a flow target on the dispensing target, and
an actuator control module, the actuator control module communicates with the targeting actuator interface to direct the dispenser nozzle at the flow target.

14. The target designating dispensing system of claim 13, wherein the actuator control module communicates through the targeting actuator interface to maintain the direction of the dispenser nozzle at the flow target with movement between one or more of the dispensing target or the flow target relative to the dispenser.

15. The target designating dispensing system of claim 14 comprising:
a motion sensor coupled with the dispenser, and
a reference location coupled with the dispensing target, the motion sensor measures movement of the reference location, wherein the targeting controller measures relative movement between one or more of the dispensing target or the flow target and the dispenser with the motion sensor and the reference location.

16. The target designating dispensing system of claim 13 comprising the dispenser, the dispenser including:
the dispenser nozzle, and
the targeting actuator coupled with the dispenser nozzle.

17. The target designating dispensing system of claim 16, wherein the dispenser includes an auger and the dispenser nozzle is a grain nozzle of the auger.

18. The target designating dispensing system of claim 16, wherein the dispenser is a liquid dispenser and the dispenser nozzle is a liquid nozzle.

19. The target designating dispensing system of claim 13 comprising a dispensing target monitor, the dispensing target monitor is in communication with the target designator and provides the representation of the dispensing target.

20. The target designating dispensing system of claim 19, wherein the dispensing target monitor communicates movement of one or more of the dispensing target or the flow target relative to the dispenser to the targeting controller, and the actuator control module operates the targeting actuator to maintain the direction of the dispenser nozzle at the flow target according to the communicated movement.

21. The target designating dispensing system of claim 13, wherein the dispensing target display includes a touch screen, and the designator reticle includes a touch based designator reticle movable with touch interaction with the touch screen.

22. The target designating dispensing system of claim 13, wherein the target designator and the controller are housed in one of a tablet computer, laptop computer, smartphone, or field computer.

23. A method for directing a dispenser to a flow target comprising:
designating a flow target for a dispenser on a dispensing target, designating including:
positioning a designator reticle at a location on a representation of a dispensing target corresponding to the flow target, and
associating the location of the designator reticle to the flow target on the dispensing target; and
directing the dispenser at the flow target according to the associated location of the designator reticle, directing including articulating the direction of the dispenser at the flow target based on the associated location of the designator reticle to the flow target.

24. The method of claim 23, wherein directing the dispenser at the flow target according to the associated location of the designator reticle includes maintaining direction of the dispenser at the flow target with relative movement of one or more of the dispensing target or the flow target relative to the dispenser.

25. The method of claim 24, wherein maintaining direction of the dispenser at the flow target with relative movement includes:
measuring movement of one or more of the dispensing target or the flow target relative to the dispenser, and
further articulating the direction of the dispenser toward the flow target based on the measured movement.

26. The method of claim 25 comprising fixing the location of the flow target relative to the dispenser at the associated location of the designator reticle to the flow target.

27. The method of claim 26, wherein measuring movement of one or more of the dispensing target or the flow target relative to the dispenser includes:
measuring a current location of the flow target relative to the previously fixed location of the flow target, and
further articulating the direction of the dispenser toward the flow target based on the difference between the current and previously fixed locations of the flow target.

28. The method of claim 23, wherein positioning the designator reticle includes using touch interaction with a screen to position the designator reticle at the location.

29. The method of claim 23 comprising generating the representation of the dispensing target, wherein generating the representation of the dispensing target includes viewing the dispensing target with a dispensing target monitor.

30. The method of claim 23 comprising repeating designating the flow target and directing the dispenser at the flow target according to positioning the designator reticle at a second location on the representation of the dispensing target corresponding to a second flow target, the second location and second flow target different from the location and the flow target.
